(19) United States
(12) Patent Application Publication
(10) Pub. No.: US 2016/0162480 A1
(43) Pub. Date: Jun. 9, 2016

(54) ADAPTIVE COMPUTERIZED MAPPING TECHNIQUE IN DATABASE SYSTEMS

(71) Applicants: Hans-Peter Schaerges, Mannheim (DE); Tim Kaiser, Leimen (DE); Marcus Hoepfner, Heidelberg (DE)

(72) Inventors: Hans-Peter Schaerges, Mannheim (DE); Tim Kaiser, Leimen (DE); Marcus Hoepfner, Heidelberg (DE)

(21) Appl. No.: 14/558,998

(22) Filed: Dec. 3, 2014

(51) Int. Cl. G06F 17/30

(52) U.S. Cl. CPC G06F 17/303

(57) ABSTRACT

The present disclosure relates to a computer-implemented method comprises obtaining one or more source database structures including a plurality of source fields, obtaining at least one target database structure including a plurality of target structures, obtaining information regarding user interactions during a past mapping process of source fields of the one or more source database structures to target fields of the at least one target database structure, automatically determining one or more proposed mappings between a set of source fields of the one or more source database structures and a set of target fields of the at least one target database structure, where automatically determining the one or more proposed mappings includes taking into account the obtained information regarding user interactions during a past mapping process of source fields of the one or more source database structures to target fields of the at least one target database structure.

### TECHNICAL FIELD

The present disclosure relates to methods and systems for database systems. In particular, the present disclosure relates to computerized techniques for mapping of source database structures to target database structures.

### BACKGROUND

Users of today's database systems can generate database models of real-world objects of considerable complexity. For defining a new database object (e.g., a database view for visualizing database data to a user) it can be required to map multiple source database objects onto a target database object. For instance, a target database object can include a visualization of sales data for a current year. In order to populate the fields of this target database object, different source database objects for visualizing the monthly sales data have to be mapped onto the target object. Each database object might be represented by a hierarchical structure including hundreds or thousands of fields that have to be mapped. Therefore, manually mapping the source fields to the respective target fields (e.g., by a drag-and-drop operation) can be a time consuming and tedious task.

### SUMMARY

In a first general aspect of the present disclosure a computer-implemented method comprises obtaining one or more source database structures including a plurality of source fields, obtaining at least one target database structure including a plurality of target fields, obtaining information regarding user interactions during a past mapping process of source fields of the one or more source database structures to target fields of the at least one target database structure, automatically determining one or more proposed mappings between a set of source fields of the one or more source database structures and a set of target fields of the at least one target database structure, where automatically determining the one or more proposed mappings includes taking into account the obtained information regarding user interactions during a past mapping process of source fields of the one or more source database structures to target fields of the at least one target database structure.

In a second aspect according to the first aspect the user interactions during a past mapping process include one or more of a definition of a mapping between a particular source field and a particular target field, a deletion of an existing mapping between a particular source field and a particular target field and a refusal of a proposed mapping between a particular source field and a particular target field.

In a third aspect according to the first or second aspect, automatically determining the one or more proposed mappings includes obtaining weights for each mapping between the set of source fields and the set of target fields, modifying at least one of the weights based on the obtained information regarding user interactions during a past mapping process and selecting a proposed mapping between each source field of the set of source fields and one of the target fields of the set of target fields based on the weights.

In a fourth aspect according to the third aspect selecting a proposed mapping between the each source field of the set of source fields and one of the target fields includes using a stable marriage algorithm.

In a fifth aspect according to the third or the fourth aspect the weights obtained for each mapping between the set of source fields and the set of target fields are static weights.

In a sixth aspect according to the fifth aspect the static weights are determined based on one or more of a data type of a source field and a respective target field, a similarity in the name or other identifier of a source field and a respective target field, a layout of the source database structure and a layout of the target database structure

In a seventh aspect according to any one of the third to sixth aspects modifying at least one of the weights based on the obtained information regarding user interactions includes increasing a weight if the user has defined a mapping between a particular source field and a particular target field.

In an eighth aspect according to any one of the third to seventh aspects modifying at least one of the weights based on the obtained information regarding user interactions during a past mapping process includes determining one or more sets of source fields including one source field of two or more source database structures of the plurality of source database structures based on a similarity of proposed mappings between the source fields in each set of source fields and the plurality of target fields and modifying a weight of a mapping of at least one source field of each set of the one or more sets of source fields if a user past user interaction has defined, deleted or refused a mapping between another source database field of the respective set of source fields and a target field.

In a ninth aspect according to any one of the third to eighth aspects modifying at least one of the weights includes increasing a weight if the user has not refused or deleted a mapping between a respective source field and a respective target field in a past user interaction

In a tenth aspect according to any one of the preceding aspects only information regarding a most recent user interaction for each source field and a respective target field is taken into account.

In an eleventh aspect according to any one of the preceding aspects, the set of source fields includes all source fields of the two or more source database structures and the set of target fields includes all target fields of the at least one target database structure

In a twelfth aspect according to any one of the preceding aspects, the method further comprises presenting the one or more proposed mappings to the user for approval or refusal.

In a thirteenth aspect according to the twelfth aspect presenting an indication to a user that one or more of the proposed mappings differ from the mappings that would be obtained when not taking into account the information regarding user interactions during a past mapping process.

In a fourteenth aspect according to any one of the preceding aspects the method further comprises displaying at least a portion of a representation of the source database structures and the target database structure and an indication of proposed and actual mappings.

In a fifteenth aspect according to the fourteenth aspect, the method further comprises updating the one or more proposed mappings after a user interaction and displaying an indication of the updated proposed and actual mappings.

In a sixteenth aspect according to any preceding aspect, the method further comprises comparing proposed mappings between source database fields of a particular source database structure of the one or more source database structures to target database fields of the target database structure with proposed mappings between source fields of one or more other source database structures of the one or more database structures to target fields of the target database structure and forming one or more sets of source database structures including source database fields which are mapped to the same target database field.

In a seventeenth aspect according to the sixteenth aspect, the method further comprises replicating a past user interaction on a source database field of the one or more sets of source database fields on another source database field of the same set of source database field to automatically determine at least one proposed mapping.

In a second general aspect of the present disclosure a computer readable medium storing instructions thereon which when executed by a processor cause the processor to perform operations of any one of the first to sixteenth aspects.

In a third general aspect of the present a System comprises one or more processors and a computer-readable medium storing instructions executable by the one or more processors to perform operations comprising operations of any one of the first to sixteenth aspects.

### BRIEF DESCRIPTION OF THE DRAWINGS

FIG. 1 illustrates the relationship between five example database structures that have to be mapped according to an implementation.

FIG. 2 illustrates a screenshot of a mapping application displaying different source and target structures according to an implementation.

FIG. 3 illustrates another screenshot of the mapping application of FIG. 2 after a user has mapped the source fields to the respective target fields according to an implementation.

FIG. 4 illustrates a set of possible mappings between two example source structures and an example target structure according to an implementation.

FIG. 5 illustrates a set of proposed mappings between two example source structures and an example target structure based on static information regarding these structures according to an implementation.

FIG. 6 illustrates a first set of proposed mappings between two example source structures and an example target structure based on information regarding user interactions during a past mapping process according to an implementation.

FIG. 7 illustrates two example source structures and an example target structure in which similar fields have been identified according to an implementation.

FIG. 8 illustrates a further set of proposed mappings between two example source structures and an example target structure based on information regarding user interactions during a past mapping process according to an implementation.

FIG. 9 illustrates user interactions during a past mapping process including defining and deleting mappings and refusing proposed mappings according to an implementation.

FIG. 10 illustrates a further set of proposed mappings between an example source structure and an example target structure based on information regarding user interactions during a past mapping process according to an implementation.

FIG. 11 illustrates a further set of proposed mappings between two example source structures and an example target structure based on the similarity of the source structures regarding their proposed mappings to the target structure according to an implementation.

### DETAILED DESCRIPTION

The present disclosure relates to methods and systems for database systems. In particular, the present disclosure relates to computerized techniques for mapping of source database structures to target database structures.

The subject-matter described in this disclosure can be implemented in particular embodiments so as to realize one or more of the following advantages:

First, the mapping tool of the present disclosure can propose multiple mappings between source and target fields to a user of a database system. The user can accept the proposed multiple mappings in go and thereby avoid a large number of manual operations (e.g., drag-and-drop operations).

Second, the mapping tool of the present disclosure can increase a likelihood that a proposed mapping will be accepted by a user by taking into account information regarding user interactions during a past mapping process. In this manner, a mapping process can be further accelerated as the number of manually mapped fields can be reduced.

Third, the mapping tool of the present disclosure can dynamically take into account information regarding user interactions during a past mapping process (e.g., a last user interaction) during the actual mapping process. In this manner, the mapping tool can rapidly improve a quality of its mapping proposals even if an initial proposal is not optimal.

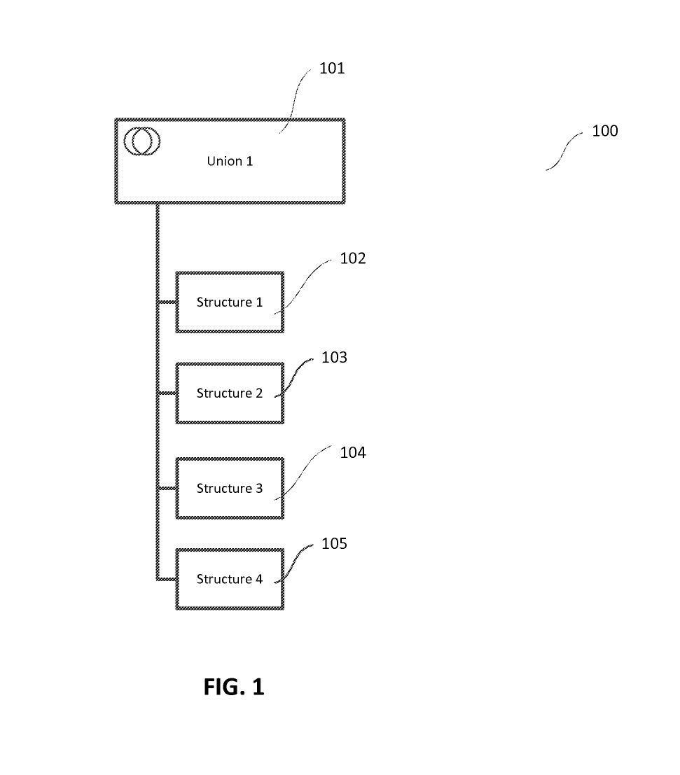

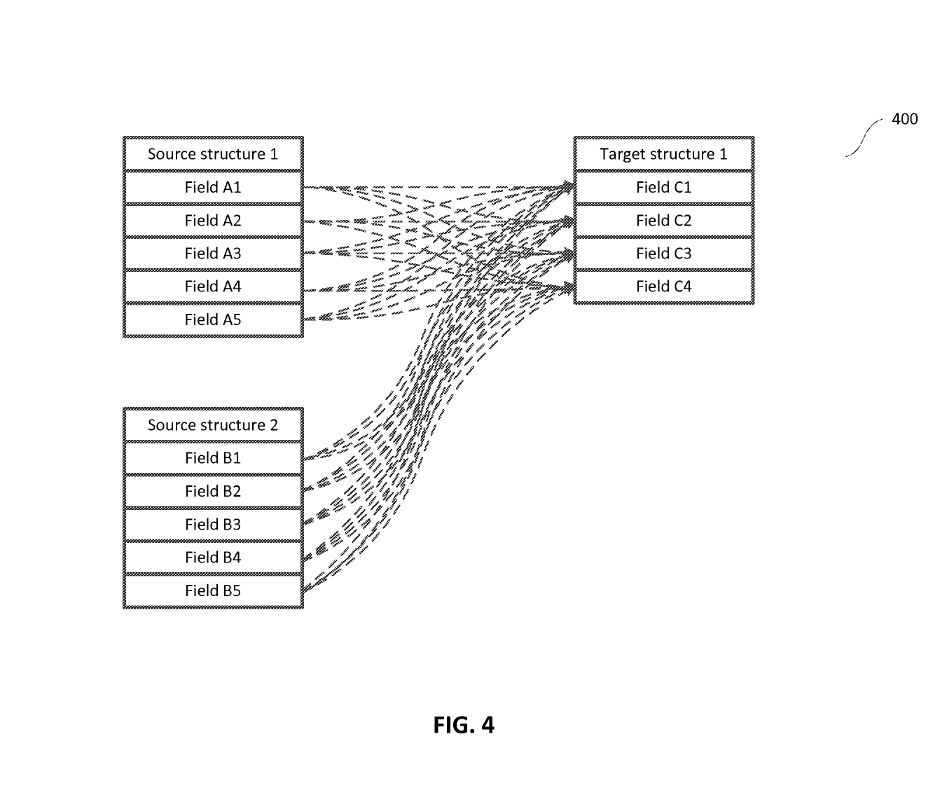

The mapping tool of the present disclosure will be subsequently discussed in connection with FIGS. 1 to 11. First, an example software environment will be described in connection with FIGS. 1 to 3. Subsequently, in connection with FIGS. 4 to 11, different techniques will be discussed of how to propose mappings between source structures and target structures based on information regarding user interactions during past mapping processes of the present disclosure.

FIG. 1 illustrates the relationship between five example database structures 101, 102, 103, 104, 105 that have to be mapped according to an implementation. First, second, third, and fourth source structures 102, 103, 104, and 105 (“structure 1” to “structure 4”) are combined into a unified hierarchical target 101 (“union 1”). This means, the fields of all source structures 102, 103, 104, 105 have been mapped to corresponding fields in the target structure 101. This process can be carried out, e.g., by an experienced user of a database system. The target structure 101 can be used by the database system to visualize the combined data of the source structures 102, 103, 104, 105 to a user of the database system. For instance, the source structure 102 can be a first view of the database system and the source structure 103 can be a second view of the database structure (e.g., for illustrating revenue data in the first quarter of 2013 and the second quarter of 2013). Then, the target structure 101 can be a database view combining the source database views 102, 103 (e.g., for illustrating revenue data in the complete year 2013).

The above-discussed combination of different source structures requires a mapping of the source fields of the source structures to the corresponding target fields of the target structure. In other words, the target data structure has to be provided with an indication where data can be found in the source database structures. This task can be carried out in a mapping tool of the database system.

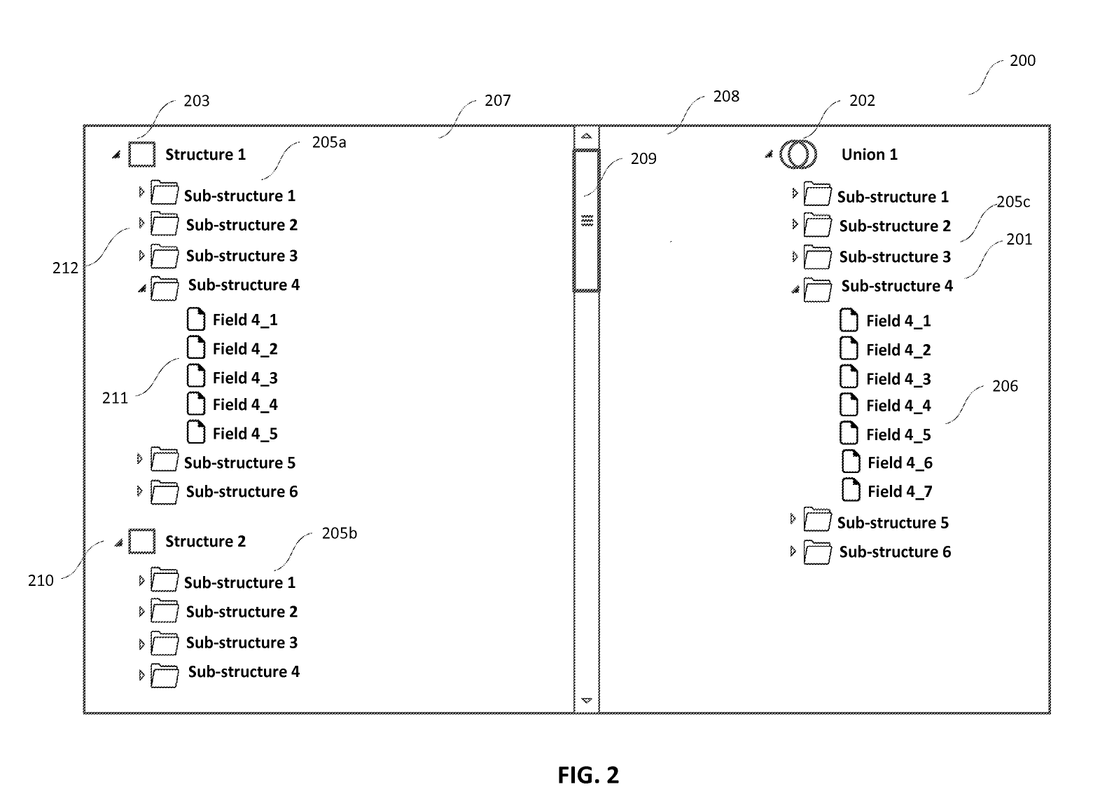

FIG. 2 illustrates an example graphical user interface 201 of a mapping tool. In the left hand side window 207 the graphical user interface 201 includes graphical representations of one or more source structures 203 and 210 (“structure 1” and “structure 2”, respectively, in FIG. 2). In the right hand side window 208, the graphical user interface 201 includes graphical representations of at least one target structure 202 (“union 1” in FIG. 2). Both the sources structures 203 and 210 and the target structure 202 can be hierarchical structures with two or more hierarchical levels of nodes and fields. As shown in FIG. 2, the source and target structures can be hierarchical trees where the fields 206, 211 are leaves of the hierarchical tree and the nodes are branches of the hierarchical tree 205a, 205b, and 205c.

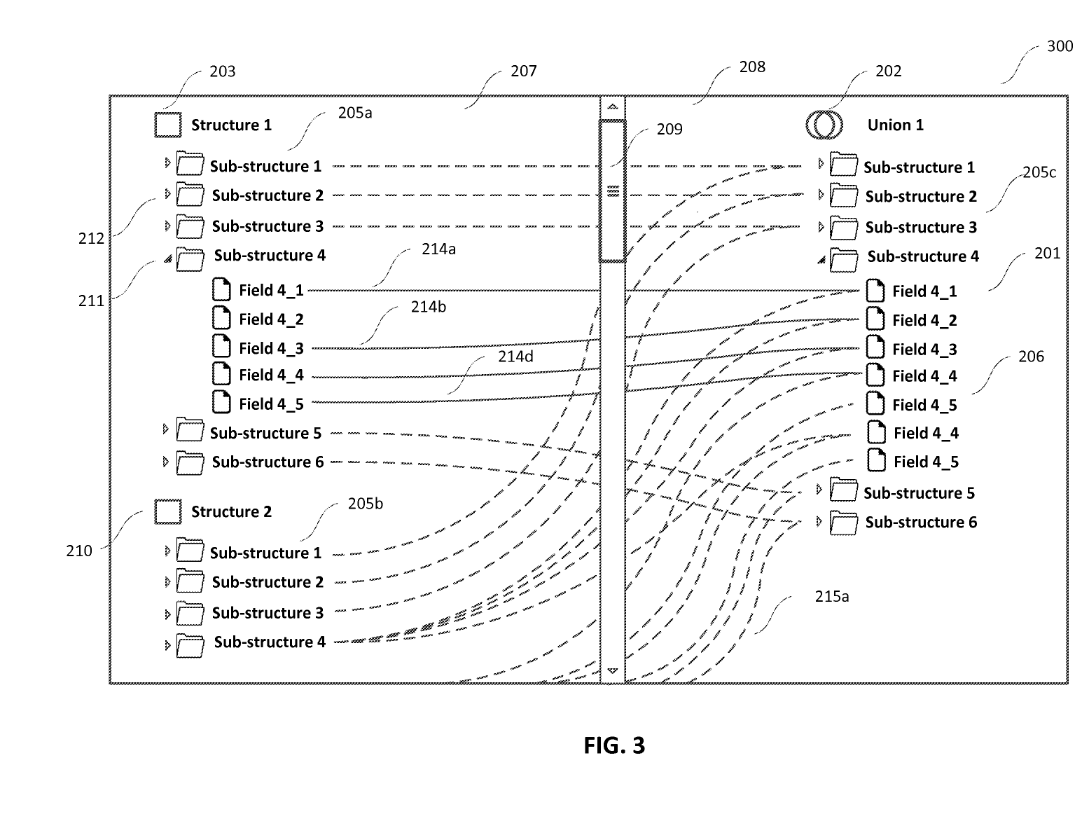

In FIG. 2, a user can be just about to start a mapping process. For example, mapping a particular source field (e.g., “source field 4_1”) onto a particular target field (e.g., “target field 4_1”) can require a drag-and-drop operation. An example of a mapped target structure is shown in FIG. 3. As can be seen, all fields of the target structure 202 have been mapped to target fields of multiple sources structure 203, 210. In example database systems there are hundreds of sources structures with hundreds or even thousands of fields (a database user can create database structures with (almost) arbitrary size and complexity, e.g., in order to model a complex business object). In this situation, the above-described manual mapping of source fields onto target fields can take a fairly long time and can be extremely tedious. Therefore, mapping tools can provide proposed mapping functionalities that provide a user with proposals for one or more mappings between source and target fields. The user can accept the proposals (e.g., a predetermined number of proposals at once) and hereby proceeds through the mapping process (much) more rapidly.

Subsequently, different mapping processes of the present disclosure will be discussed in connection with FIGS. 4 to 12. In general, the techniques of the present disclosure take into account information regarding user interactions during a past mapping process of source fields of to target fields of the particular source structures and target structures being mapped. In this manner, mapping proposals can be dynamically generated and updated while the user maps the particular sources structures to the particular target structure.

In some cases, this can improve a quality of mapping proposals compared to techniques involving using “static information.” In the present disclosure, “static information” includes information that is provided to a mapping tool at the start of a particular mapping process. This can include, e.g., a dictionary of mappings between particular source fields and particular target fields. For instance, a mapping from a source field “article no.” onto a target field “art. ser. no.” can be included in a dictionary when a particular user notices that both field names are used to refer to the same field (i.e., a field containing serial numbers of articles) throughout a company. However, this information is still static as, during a particular mapping process, it is not generated, modified, or updated.

In other cases, a mapping tool can use historic information of previous mapping processes between other source structures and target structures for providing mapping proposals for a current mapping process. Again, this historic information is static as, for a particular mapping process, it is not generated, modified, or updated.

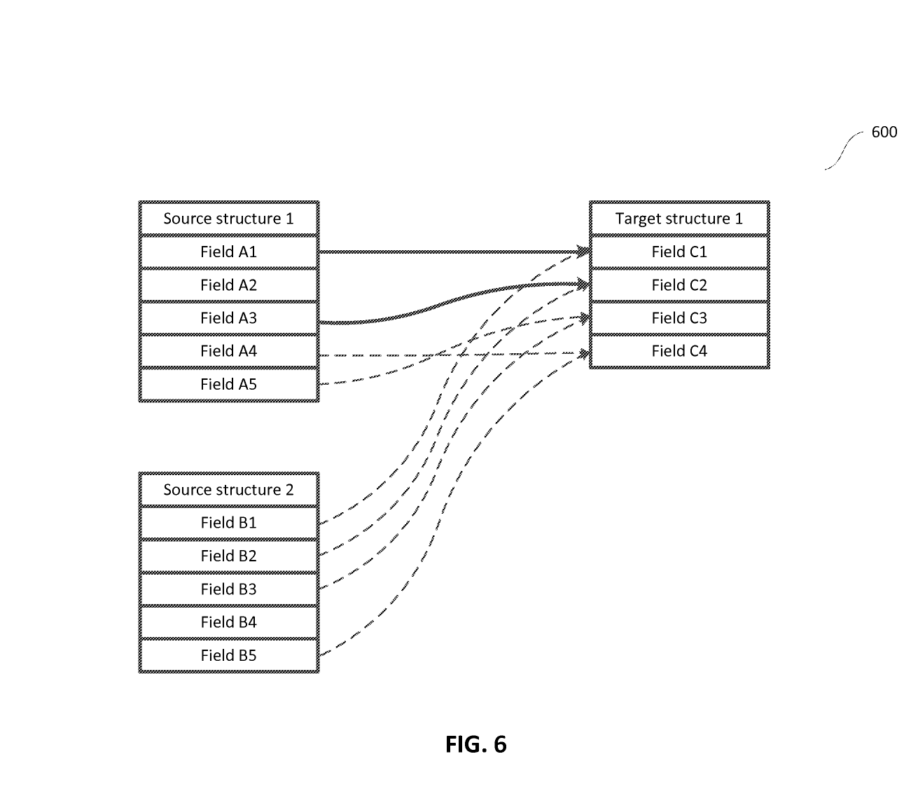

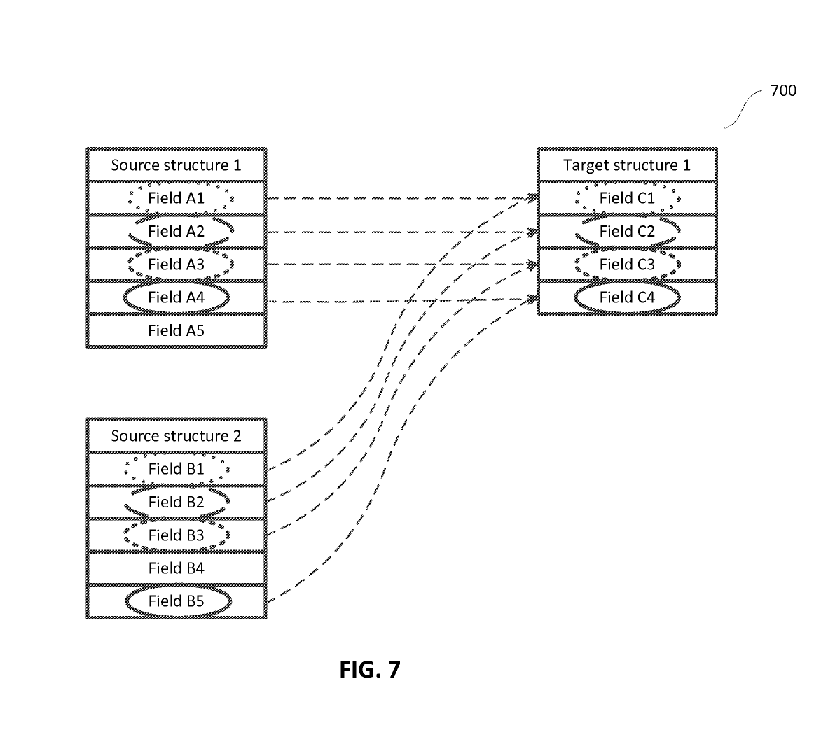

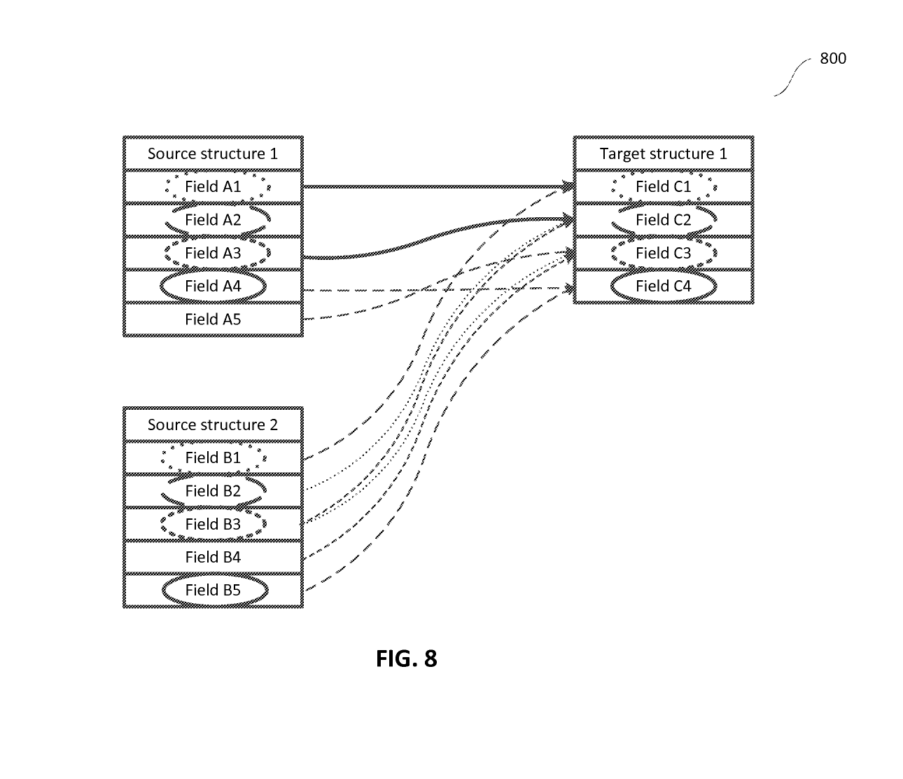

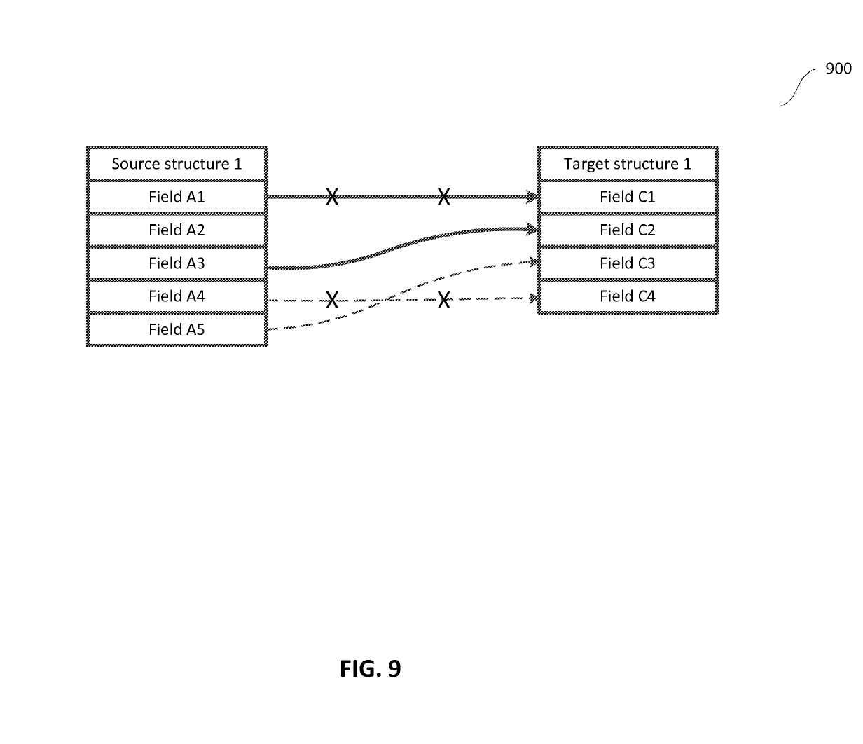

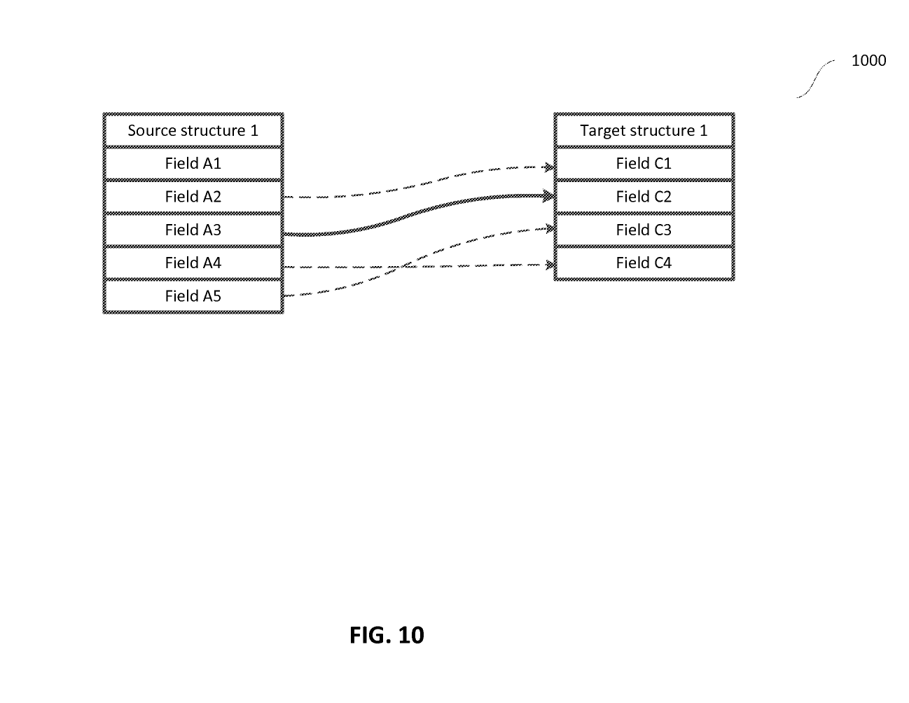

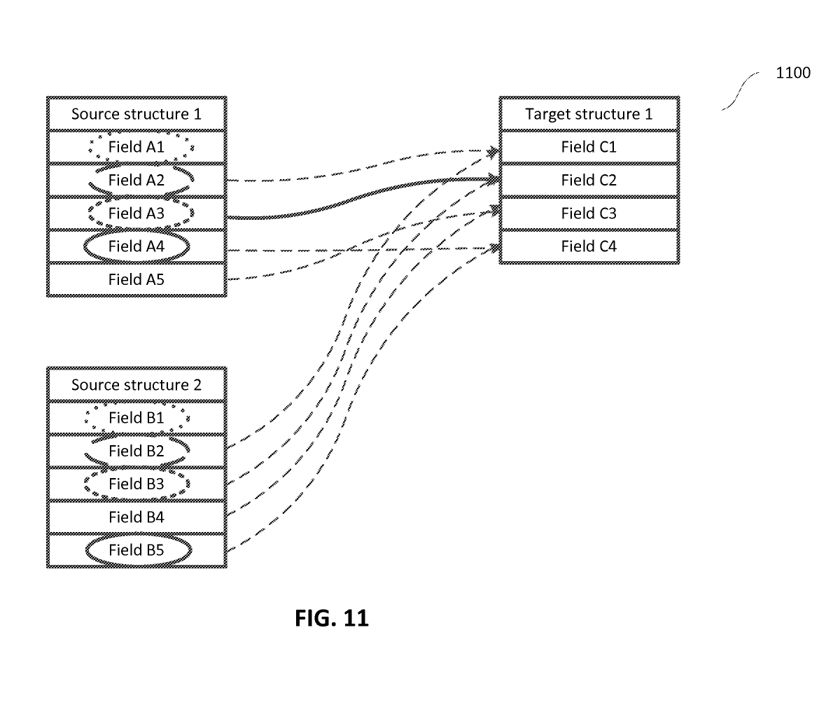

In the following sections, different techniques of how user interactions during a past mapping process of source fields of to target fields of the particular source structures and target structures being mapped can be used will be described. In connection with FIG. 6, it will be discussed how user generated definitions of a particular mapping can be used to dynamically generate mapping proposals. In connection with FIGS. 7 and 8, a second approach taking into account similarities between source structures for dynamically generating mapping proposals will be explained. FIGS. 9 and 10 show an example of how deletions of existing mappings or refusals of proposed mappings during a particular mapping process can be used by the mapping tool to generate mapping proposals. Lastly, in connection with FIG. 11, an example mapping tool combining all discussed techniques will be discussed (e.g., user definitions and deletions of mappings, refusals of proposed mappings, and similarities between source structures are taken into account for dynamically proposing mappings).

However, in other examples, only a portion of the techniques discussed above can be implemented in a mapping tool. For instance, a mapping tool can only take into account user interactions including definitions of a mapping between a particular source field and a particular target field, deletions of an existing mapping between a particular source field and a particular target field and refusals of a proposed mapping between a particular source field and a particular target field. In other examples, the mapping tool can only take into account user interactions including definitions of a mapping between a particular source field and a particular target field and similarities between the different source structures. In still other examples, the mapping tool can only take into account user interactions including deletions of an existing mapping between a particular source field and a particular target field and refusals of a proposed mapping between a particular source field and a particular target field and similarities between the different source structures.

As can be seen in FIG. 4, the following discussion is based on a fairly simple example including two source structures (“source structure 1” and “source structure 2”) each having five source fields and a single target structure (“target structure 1”) having four target fields. This simple example is chosen for the sake of clarity. The techniques of the present disclosure can be equally applied in more complex situations (e.g., involving a larger number of source structures, source and target structures with a larger number of source fields and target fields, or source and target structures with a larger number of hierarchical levels).

In FIG. 4, all possible mappings between the source fields and the target fields are illustrated. In many examples, a valid mapping includes at most a single mapping (or none) from a particular source field. On the other hand, a particular target field can have different source fields which are mapped onto the particular target field. In many examples, all target fields have to be fully mapped (i.e., have at least one mapping of each source structure) at the end of a mapping process. Even though some of the concrete examples described below produce a proposed mapping that secures this property, the technique of taking into account information regarding user interactions during a past mapping process of a particular source structures to target fields of a particular target structure can also be employed in situations where a valid mapping does not have to have the above discussed property.

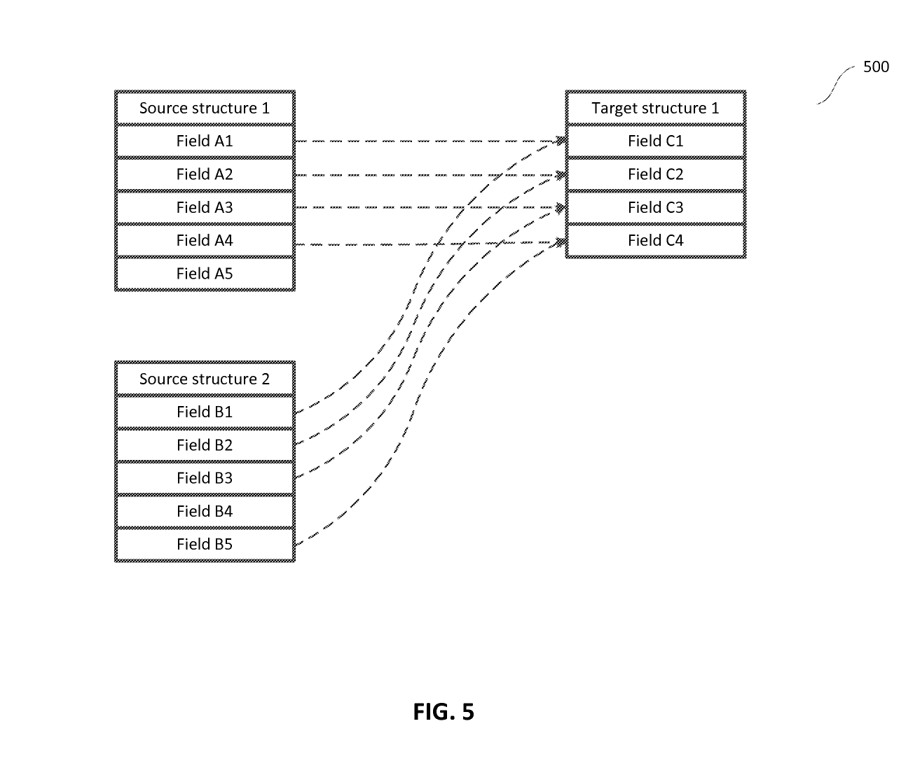

FIG. 5 depicts an example valid mapping having the property discussed in the previous section. Each source field is at most mapped onto a single target field. In the following sections, an example technique will be discussed for proposing mappings between source and target fields. In one example, the mapping tool can obtain a static weight for each possible mapping between source and target structures. A high numerical value of a weight can indicate that a particular source field has a high likelihood to be mapped onto a particular target field. On the other hand, a low numerical value of a weight can indicate that a particular source field has a low likelihood to be mapped onto a particular target field. The particular numerical values and their ranges can be arbitrarily defined. In other examples, a high numerical value of a weight can indicate that a particular source field has a low likelihood to be mapped onto a particular target field (and vice versa). The techniques described herein can be easily modified to operate with this range of weights.

The set of weights for mappings between the i-th source structure and the target structure can be expressed as the result of a weighting function, for example: [symbol] ᵢ: Sᵢ×T→[numerical range of weights]. Thus, for each possible mapping between a field of the i-th source structure and a field of the target structure, the function SWF, yields a particular weight.

The mapping tool can use a set of predefined weights. For instance, the predefined weights can be determined by taking into account the static information discussed above. Additionally or alternatively, the predefined weights can take into account information regarding the particular source and target structures. In one example, a weight for a mapping between a particular source field and a particular target field can be determined based on a similarity of the field names (e.g., a source field “revenue” might be a good candidate to be mapped onto a target field “total revenue”). In addition or alternatively, a weight for a mapping between a particular source field and a particular target field can be determined taking into account a data type of the particular source field and the particular target field (e.g., a source field having a data type “string” might not be good candidate to be mapped onto a target field with the data type “integer”). Additionally or alternatively, a weight for a mapping between a particular source field and a particular target field can be determined taking into account information regarding the hierarchical structure of the source and target structures. However, all mappings based on the previously discussed information are static in that the name, data type and hierarchical structure of the source and target objects do not change during a particular mapping process.

In Table 1 below, a set of example (static) weights is shown. In this representation, the weights are arranged in a matrix where each row relates to a source field and each column relates to a target field. Therefore, for example, the weight in row “A2” and column “C2” is the weight assigned to a mapping between source field “A2” and target field “C2.” In this example, the weights range from zero (depicted as “-” in Table 1) to lower than 1. For instance, a static weight of 0.9 indicates that a mapping between the respective source and target fields is likely (based on the information used for determining the weights). On the other hand, a static weight of 0.1 indicates that a mapping between the respective source and target fields is not likely (again, based on the information used for determining the weights). For instance, field “A5” of source structure “S1” might be a good candidate to be mapped onto target field “C3” of the target structure.

TABLE 1

Target Structure

| | | | | |
|---|---|---|---|---|
| [symbol] | C1 | C2 | C3 | C4 |

| | | | | | |
|---|---|---|---|---|---|
| S1 | A1 | 0.90 | 0.81 | 0.72 | — |
| | A2 | 0.60 | 0.90 | — | — |
| | A3 | — | 0.20 | 0.90 | 0.10 |
| | A4 | 0.50 | — | — | 0.90 |
| | A5 | 0.40 | 0.30 | 0.80 | — |
| S2 | B1 | 0.90 | 0.81 | 0.72 | — |
| | B2 | 0.60 | 0.90 | — | — |
| | B3 | — | 0.20 | 0.90 | 0.10 |
| | B4 | 0.40 | 0.30 | 0.80 | — |
| | B5 | 0.50 | — | — | 0.90 |

Based on a set of weights for mappings between source fields and target fields, the mapping tool can determine a set of proposed mappings. This can involve using an optimization technique. In one example, the mapping tool uses solutions to the “stable marriage problem” known in the field of numerical optimization. A pseudo-code example of the stable matching algorithm for solving a “stable marriage problem” that can be used for determining a set of proposed mappings between the i-th source structure and a target structure is reproduced below. In the pseudo-code example “t” denotes a particular target field of the target structure “T.” Moreover, “s” denotes a particular source field of the i-th source structure “Sᵢ.”

function stableMatching {

Initialize all t ∈ T and s ∈ Sᵢ to free
while ∃ not yet mapped target field t which still has a source field s to

“propose to” {

s is highest ranked target field to which t has not yet “proposed”
if s is not yet mapped

(t, s) become mapped

else some mapping (t′, s) already exists

if s prefers t to t′

(t, s) become mapped
t′ becomes free

else

(t′, s) remain mapped

}

}

By using the stable matching algorithm, the mapping tool can determine a set of proposed mappings between source structures and a target structure. A solution of the stable matching algorithm for the static weights shown in table 1 is depicted in FIG. 5.

The mapping tool can propose a first set of mappings based on the static weights determined as discussed above. For instance, the mapping tool can, at the beginning of a mapping process of two or more source structures onto at least one target structure, display the proposed mappings determined based on the static weights to a user. The user can then accept or refuse the proposed mappings (one-by-one or in groups) and commence with the manual mapping process. During this manual mapping process, the mapping tool monitors user interactions that can be used to refine the mapping proposals. Different types of user interactions and how they can be used to refine the mapping proposals will be discussed in the following passages.

In a first example, the user can define one or more mappings between source fields and target fields manually. The mapping tool can then determine one or more proposed mappings taking into account the obtained information regarding user interactions of defining the or more mappings between source fields and target fields manually. FIG. 6 shows an example where the user has defined two mappings. A first mapping maps the source field A1 of source structure 1 onto the target field C1, a second mapping maps the source field A3 of source structure 1 onto the target field C2. As can be seen when comparing these two user-defined mappings with the mapping tool proposed mappings of FIG. 5, the mapping of source field A3 deviates from the proposal calculated based on the static weights. As a consequence, the mapping tool of the present disclosure updates the proposed mappings based on the obtained information regarding the user interaction. In this respect, the mapping tool dynamically modifies the proposed mappings. For example, the mapping tool can propose updated mappings only for source fields and target fields which are not part of a user defined mapping. In addition or alternatively, a weight of a mapping that is user defined can be increased.

An example technique for including previous user defined mappings will now be discussed. In a first operation, the mapping tool can determine a set of mappings which are user-defined. These mapping can be described as a binary relation, for example:

$$⊆ ( {⋃}_{i} {S}_{i} ) \times T$$

where (s, t)
∈ [symbol] if and only if there is a user-defined mapping between s and t.

Then, the mapping tool can calculate an updated proposal only for those source fields and target fields which do not form part of a user-defined mapping (i.e., which are not members of the set [symbol] ). In Table 2, the results of the two user-defined mappings are illustrated by greying out the weights of mappings that are no longer available.

TABLE 2

Target Structure

| | | | | |
|---|---|---|---|---|
| [symbol] | C1 | C2 | C3 | C4 |

| | | | | | |
|---|---|---|---|---|---|
| S1 | A1 | 0.90 | 0.81 | 0.72 | — |
| | A2 | 0.60 | 0.90 | — | — |
| | A3 | — | 0.20 | 0.90 | 0.10 |
| | A4 | 0.50 | — | — | 0.90 |
| | A5 | 0.40 | 0.30 | 0.80 | — |
| S2 | B1 | 0.90 | 0.81 | 0.72 | — |
| | B2 | 0.60 | 0.90 | — | — |
| | B3 | — | 0.20 | 0.90 | 0.10 |
| | B4 | 0.40 | 0.30 | 0.80 | — |
| | B5 | 0.50 | — | — | 0.90 |

As can be seen, the rows of source fields A1 and A3 and the columns of target fields C1 and C2 have been greyed out as they form part of a user-defined mapping. With the reduced set of source fields and target fields as an input, the mapping tool can determine a set of proposed mappings. For instance, the mapping tool can employ the stable matching algorithm described above. FIG. 6 illustrates the outcome of this optimization. As can be seen, taking into account the user interaction results in an updated mapping of the source fields A2, A3, and A5. For instance, whereas using the static weights have resulted in no mapping from source field A5 (see FIG. 5), the dynamically adjusted mapping includes a mapping from source field B5 onto target field C3. This proposal might be a better guess for the actual mapping. Thus, a user presented with this proposal can proceed with the mapping process by simply accepting the proposed mapping.

Besides (or additionally) taking into account user defined mappings, the mapping tool can also update proposed mappings based on a similarity between source fields of a first source structure (e.g., an i-th source structure Sᵢ) and source fields of a second source structure (e.g., an j-th source structure Sⱼ) with respect to their probable (or improbable) target fields. This can include comparing proposed mappings between source fields of a particular source structure to target fields of a target structure with proposed mappings between source fields of one or more other source structures to target fields of the target structure. If the proposed mappings of two source fields of two different source structures include the same target field, the mapping tool can determine that these source fields are similar. The proposed mappings can be determined by applying the stable matching algorithm described above.

For example, the mapping tool can execute the stable matching algorithm using the static weights of the mappings between source and target fields for a plurality of sources structures obtained at the beginning of a mapping process. This can result, as discussed above, in a set of proposed mappings (e.g., one proposed mapping between each field of the target structure and one source field of each source structure). In a second step, the mapping tool can determine which source fields of the different source structures are mapped to a particular target field according to the calculated proposed mappings. These source fields can be considered as similar source fields (as they are assigned to the same target field by the stable matching algorithm). In other examples, the proposed mappings can be determined by another algorithm. The techniques of the present disclosure to determine sets of similar source fields and use this information for adapting mapping proposals of a source field in one source structure based on past user interactions with a mapping proposal of another, similar source field can be employed irrespective of the particular algorithm to calculate mapping proposals.

FIG. 7 illustrates a set of similar source fields in the source structures 1 and 2 (similar source fields are encircled by a line having the same line style). For instance, field A4 of source structure 1 has been found to be similar to field B5 of source structure 2. The mapping tool has found that both source field A4 of source structure 1 and source field B5 of source structure 2 are mapped to the same target field C5 when executing the stable matching algorithm (i.e., the mapping proposals of both source fields includes the same target field). The mapping tool therefore determines that source fields A4 and B5 are similar.

This can be expressed in a more formal manner as follows. An example set-valued function “Similar fields of Sᵢ” can be defined as:

$${S}_{i} \to ( {\dot{⋃}}_{j \neq i} {S}_{j} )$$

Similar fields of Sᵢ:
where, for example:

$$Similar fields of {S}_{i} ( s ) = \{ \begin{matrix}∅ & if ∄ t ∈ T \text{:} ( s ) = t \\ {⋃}_{j \neq i} \{ {s}^{′} ∈ {S}_{j} \text{:} ( {s}^{′} ) = ( s ) \} & if ∃ t ∈ T \text{:} ( s ) = t\end{matrix}$$

In the example of FIG. 7, the mapping tool has determined that source field A1 is similar to source field B1, source field A2 is similar to source field B2, source field A3 is similar to source field B3 and source field A4 is similar to source field B5. As already explained, the mapping tool can determine the similarities based on the proposed mappings (which are the result of the application of the stable matching algorithm). Even though the example of FIG. 7 involves only two source structures, the determination of similarities can be extended to more than two source structures (e.g., all source structures to be mapped). In these examples, each set of similar source fields can include more than two source fields of the respective source structures (e.g., one source field of each of the more than two source structures).

It has been explained above how the mapping tool determines similarities between source fields of different source structures. In a subsequent operation, the mapping tool can use this information in combination with information regarding user interactions during a past mapping process to determine one or more proposed mappings. In general, the mapping tool can take into account user interactions during a past mapping process of a first source field of a first source structure when proposing a mapping of a second source field of a second source structure when the first and second source fields have been found to be similar. In general, the mapping tool can reproduce a user interaction with a mapping of the first field to a particular target field when proposing a mapping of a second, similar source field. For instance, if the user has defined a mapping between source field A3 and target field C2, the mapping tool can propose a mapping between the similar source field B3 and the target field C2. In this manner, information regarding a similarity of A3 and B3 regarding their probable mappings to a target structure including C2 can be used to refine proposed mappings based on user interactions.

This can involve the following operations. In a first operation, the mapping tool can expand the range of possible weights of the weighing function to account for the determined similarities. In other words, the mapping tool can define a “similarity-adjusted” weighing function. In one example, the numerical range can be extended from including an upper limit for the weights of lower than 1 to including an upper limit of the weights of 1 (see Tables 1 and 2 above). The previously excluded weight value of 1 can be given to weights of mappings between source and target fields for which the user has defined a mapping (set [symbol] as defined above). Thus, an example adjusted weight function: [symbol] 1ᵢ:Sᵢ×T→[0,1] can be formulated as follows:

$${1}_{i} ( s , t ) = \{ \begin{matrix}1 & if & ∃ {s}^{′} ∈ Similar fields of {S}_{i} ( s ) \text{:} & ( {s}^{′} , t ) ∈ \\ { }_{i} ( s , t ) & else & and ∀ {s}^{″} ∈ Similar fields of {S}_{i} ( s ) , ∀ {t}^{′} \neq t \text{:} & ( {s}^{″} , {t}^{′} ) ∉\end{matrix}$$

In other examples, the value of the weight of the particular mapping is increased to another value or by a particular amount. The particular value or amount can be predefined. For example, in the concrete example above the values for a weight of a user defined mapping is higher than the static weights. This means that a user defined mapping trumps any system defined mappings. Unless the weights are further modified (e.g., as explained below), the second source structure fields similar to first structure fields with user-defined mappings will be mapped identically in the proposed mappings.

In Table 3 below, the weights of an example adjusted weight function are listed.

TABLE 3

Target Structure

| | | | | |
|---|---|---|---|---|
| [symbol] | C1 | C2 | C3 | C4 |

| | | | | | |
|---|---|---|---|---|---|
| S1 | A1 | 0.90 | 0.81 | 0.72 | — |
| | A2 | 0.60 | 0.90 | — | — |
| | A3 | — | 0.20 | 0.90 | 0.10 |
| | A4 | 0.50 | — | — | 0.90 |
| | A5 | 0.40 | 0.30 | 0.80 | — |
| S2 | B1 | 1.00 | 0.81 | 0.72 | — |
| | B2 | 0.60 | 0.90 | — | — |
| | B3 | — | 1.00 | 0.90 | 0.10 |
| | B4 | 0.40 | 0.30 | 0.80 | — |
| | B5 | 0.50 | — | — | 0.90 |

As can be seen, the weights of the mappings of the second source structure S2 are adjusted in response to the two user-defined mappings of the first source structure. The source fields B1 and B3 are mapped onto the target fields C1 and C2, respectively, with a weight of 1,00.

The adjusted weight function introduced above can again be used by the mapping tool to determine a set of proposed mappings. The determination can include using the stable matching algorithm described above. FIG. 8 illustrates a resulting set of proposed mappings. As can be seen, the first source structure is mapped in the same manner as in FIG. 6 (i.e., the two user defined mappings are taken into account). In the proposed mappings of the second source structure, however, the mapping tool changes the proposed mappings based on the similarity between the source fields of the source structure 1 and the source structure 2. As can be seen, there is no longer a proposed mapping between source field B2 and target field C2 and between the source field B3 and the target field C3 (the previously existing mappings is illustrated by a dotted line). Instead, the mapping tool proposed two new mappings between the source field B3 and the target field C2 and between the source field B4 and target field C3 (see FIG. 8). In this manner, the information regarding the user interactions is not only used to improve the mappings of the source structure they actually concerned, but also to improve the proposed mappings of other source structures having similar source fields with respect to the mapping to the target structure.

In the previous sections, examples of how similarities between source fields of different source structures to be mapped onto a target structure can be used have been discussed where the mapping tool takes into account user-defined mappings. However, these techniques can also be used in connection with other past user interactions. For example, a user can delete a previously defined mapping of a first source field in a first source structure. The mapping tool can use this information to avoid proposing a mapping between a second source field of a second source structure being similar to the first source field and the target field. For example, a weight of the mapping can be set to zero. In another example, a weight of the respective mapping can be reduced to a particular value or by a particular amount. The mapping tool can calculate an adjusted set of proposed mappings based on the adjusted weights.

In still other examples, a user can refuse a proposed mapping between a first source field and a target field. As in the case of a deleted mapping, mapping tool can use this information to avoid proposing a mapping between a second source field of a second source structure being similar to the first source field and the target field. For example, a weight of the mapping can be set to zero. In another example, a weight of the respective mapping can be reduced to a particular value or by a particular amount. For example, if the mapping tool also takes into account if the user has deleted a particular existing mapping, a numerical value of the weight assigned to a refused mapping can be higher than a numerical value of the weight of a deleted mapping. The mapping tool can calculate an adjusted set of proposed mappings based on the adjusted weights.

In the following description, a further way to use user interactions will be discussed. Here, the mapping tool can take into account user interactions including deletions of existing mappings or refusals of proposed mappings. An example set of deleted mappings (“ [symbol] ”) can be formally defined as follows:

$$⊆ ( {⋃}_{i} {S}_{i} ) \times T ,$$

where (s, t)
∈ [symbol] if and only if the last explicit action on the pair (s, t) was to delete the according mapping. An example set of refused mappings (“ [symbol] ”) can also be formally defined as follows:

$$⊆ ( {⋃}_{i} {S}_{i} ) \times T ,$$

where (s, t)
∈ [symbol] if and only if the last explicit action on (s″,t) was to refuse it as a proposal.

An example of these types of user interactions is illustrated in connection with FIG. 9. A user has in a first step defined mappings between source fields A1 and C1 and A3 and C2. Somewhat later, the user deletes the previously defined mapping between source field A1 and target field C1. In addition, the user refuses the proposed mapping between source field A4 and target field C4. The mapping tool can determine an updated set of proposed mappings based on these user interactions. For example, the mapping tool can avoid that a mapping deleted by a user is proposed again in a future set of proposed mappings. Additionally or alternatively, the mapping tool can avoid that a mapping refused by a user can be proposed again in a future set of proposed mappings. In other examples, the mapping tool can reduce the likelihood that a mapping deleted by a user is proposed again in a future set of proposed mappings. Additionally or alternatively, the mapping tool can reduce the likelihood that a mapping refused by a user is proposed again in a future set of proposed mappings.

For instance, a weight of a mapping deleted by a user or a weight of a mapping which was proposed to and refused by a user can be reduced by a particular amount. In other examples, a weight of a mapping deleted by a user or a weight of a mapping which was proposed to and refused by a user can be reduced to a particular value. In this manner, a likelihood that a previously refused or deleted mapping is again being proposed by the mapping tool in a future proposal can be influenced.

An example technique of taking into account defined, refused, and deleted mappings for proposing a set of mappings will be discussed in the following description. Again, an adjusted weight function is defined taking into account the above user interactions. For each source structure Sᵢ, an example adjusted weight function can be defined as:

[symbol]

2ᵢ:Sᵢ×T→[0,6],

where, for example:

$${2}_{i} ( s , t ) = \{ \begin{matrix}0 & \\ ( s , t ) & if \\ ( s , t ) + 1 & if \\ ( s , t ) + 4 & if \\ 6 & if \end{matrix}$$

Therefore, all mappings corresponding to actual user defined mappings are set to a constant value of 6. In addition, all weights that were zero in the static set of weights (i.e., in the set of weight obtained at the beginning of the actual mapping process) are set to zero. All other weights are set to their static set of weight plus a predetermined constant. In the example above, this constant is zero for deleted mappings and to 1 for refused mappings. In addition, the constant is 4 for all mappings which are neither in the set of defined mappings, refused mappings or deleted mappings (“(s, t)∉ [symbol] \dot{∪} [symbol] \dot{∪} [symbol] ”). In other examples, the above weights can be adjusted in a different manner. For instance, weights which have the value zero keep this value and will not be proposed during a complete mapping procedure unless explicitly selected. In other examples, a weight of zero can be treated as a “normal static weight.” In still other examples, refused and deleted mappings can be weighted equally. In still other examples, a user defined mapping's weight can only be increased by a particular amount.

As a result, the table of weights for the adjusted weight function [symbol] 2ᵢ can assume the following form.

TABLE 4

Target Structure

| | | | | |
|---|---|---|---|---|
| [symbol] | C1 | C2 | C3 | C4 |

| | | | | | |
|---|---|---|---|---|---|
| S1 | A1 | 0.90 | 4.81 | 4.72 | — |
| | A2 | 4.60 | 4.90 | — | — |
| | A3 | — | 6 | 4.90 | 4.10 |
| | A4 | 4.50 | — | — | 1.90 |
| | A5 | 4.40 | 4.30 | 6 | — |

Based on these weights, the mapping tool can determine a set of adjusted proposed mappings. For instance, the mapping tool can use the stable matching algorithm discussed above. A resulting set of proposed mappings is illustrated in FIG. 10. As can be seen, the deleted mapping between source field A1 and target field C1 is no longer part of the proposed set. On the other hand, the refused proposal between source field A4 and target field C4 is again proposed.

As becomes clear in the example discussed above, a user might interact multiple times with a particular mapping. For instance, the mapping between source field A1 and target field C1 is first user defined and later deleted by the user. In some examples, the mapping tool only takes into account a most recent user interaction with a particular mapping between a source field and a target field. In this manner, a particular mapping can only be member in one of the sets of user-defined, deleted or refused mappings at any given time (even though the membership status of a particular mapping can change with each new user interaction).

A last example for a mapping tool of the present disclosure combines all four aspects discussed above. That is, the mapping can take into account user defined mappings, deleted mappings and refused mappings, and similarities between source fields in different source structures. Again, for every source structure Sᵢ an example adjusted weight function [symbol] 3ᵢ:Sᵢ×T→[0,6] can be defined, where:

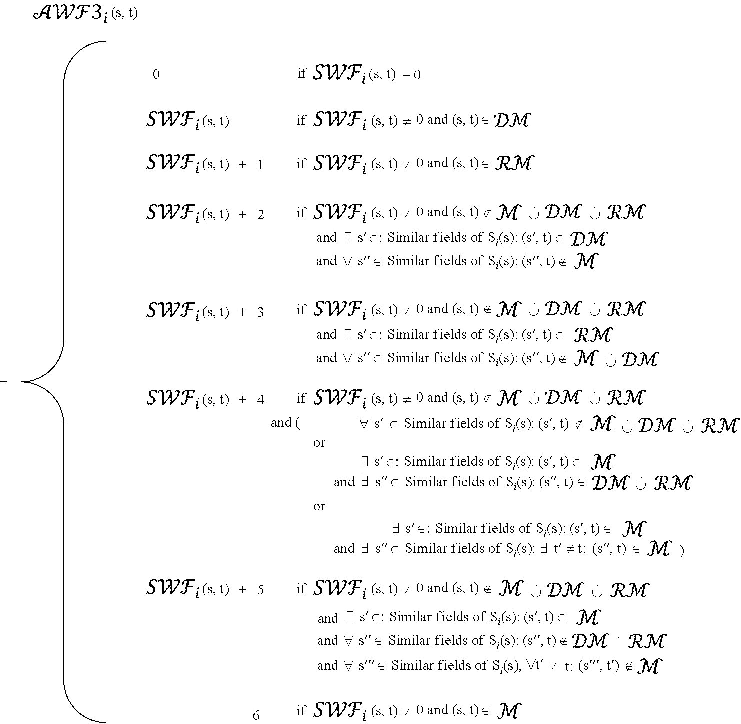

As can be seen, the first three classes of mappings and the last class of mappings (including defined mappings, deleted mappings, refused mappings or mappings whose static weight is zero) are treated equally as in the previous example (see FIGS. 9 and 10).

However, the case in which there is no user-defined mapping, deleted or refused mapping, and the static weight is non-zero is split into a plurality of different classes depending on a status of similar source fields in other source structures. Again a status of a similar field can be influenced by deleting a corresponding mapping, refusing a corresponding mapping or defining a corresponding mapping.

As can be seen above, the adjusted weight function [symbol] 3ᵢ is adjusted based on the existence of a single similar field being member of a particular set (deleted, refused, rejected) and the non-existence of a single similar field being member of one or two others sets. For example, if there is a single similar field being member in the set [symbol] , and if there is not a single similar field that is member in the set [symbol] , the weight is increased by 2. In other words, the existence of a similar field for which the corresponding mapping to a target field has been deleted shall result in a relatively low weight for i-th mapping for a particular source field. However, only if there are not any further similar source fields which have user defined mappings. In this case, taking into account the similar source fields does not yield an ambiguous result. The particular mapping will be treated as if no user interactions had taken place for similar source field (i.e., its weight is increased by 4).

Furthermore, the mapping tool checks if there is a similar source field has single similar source field which is a member in the set of refused mappings and if there is not a single similar source field which is in the set of defined or deleted mappings. In this case, a weight of the particular mapping is increased by three. That is, having a similar field for which a mapping has been refused is not penalized as harshly as having a similar field for which an existing mapping has been deleted.

In addition, the mapping tool checks if there is a similar field which has a user-defined mapping, and if there is not a single similar source field for which a mapping has been deleted or refused, or which has an existing mapping onto another target field as the target field in question. Gain, this combination of requirements ensures that the information based on the set of similar fields is only used if there is an unambiguous result.

In other examples, information concerning similar fields can be used in a different manner. For instance, in one example the mapping tool could check if a majority of similar source fields have deleted, defined or refused mappings. In this example, a mapping could be classified depending on the “majority opinion” of the similar source fields.

In general, the example of the adjusted weight function [symbol] 3ᵢ(s,t) separates the mappings in different classes based on their membership in the sets of defined, refused and deleted mappings and the membership of similar source fields in the sets of defined, refused and deleted mappings. For the similar source fields, it can also be taken into account if theses source fields are not member in a particular set. The mapping tool proposes mappings by using a particular hierarchy of the different classes of potential mappings.

Returning to the example of FIG. 11, the weights of the example adjusted weight function [symbol] 3ᵢ(s,t) can assume the following form:

TABLE 5

Target Structure

| | | | | |
|---|---|---|---|---|
| [symbol] | C1 | C2 | C3 | C4 |

| | | | | | |
|---|---|---|---|---|---|
| S1 | A1 | 0.90 | 4.81 | 4.72 | — |
| | A2 | 4.60 | 4.90 | — | — |
| | A3 | — | 6 | 4.90 | 4.10 |
| | A4 | 4.50 | — | — | 1.90 |
| | A5 | 4.40 | 4.30 | 6 | — |
| S2 | B1 | 2.90 | 4.81 | 4.72 | — |
| | B2 | 4.60 | 4.90 | — | — |
| | B3 | — | 5.90 | 4.90 | 4.10 |
| | B4 | 4.40 | 4.30 | 4.80 | — |
| | B5 | 4.50 | — | — | 3.90 |

Again, the mapping tool can determine a set of proposed mappings based on these modified weights. A resulting mapping is illustrated in FIG. 11.

In the previous sections, different examples how a mapping tool can determine a set of proposed mappings have been discussed. As already explained, the mapping tool might provide the present the proposed mappings to the user for accepting or refusing the proposed mapping. For example, the user can accept or refuse a particular proposed mapping or a group of proposed by a user interaction with the presented proposals (e.g., checking a check box displayed next to each proposed mapping). In other examples, the user can interact with an illustration of a proposed mapping in the graphical user interfaces of the mapping tool (e.g., a line connecting the source an target field of the mapping). In addition, the mapping tool can provide the user with information regarding a proposed mapping based on the static weights only. For example, a first list of the graphical user interface might include all mapping proposals determined based on the static weights. A second list can include all current mapping proposals taking into account previous user interactions. A mapping that is different from a mapping based on static information can be highlighted.

In other examples, the mapping tool can automatically define a number of mappings based on the proposed mappings without an explicit user interaction.

In the previous sections, the mapping tools of the present disclosure have been described in a functional manner. The methods and systems of the present disclosure can be embodied in different hardware and software environments, as will be discussed in the subsequent sections.

At a high level, a computer system providing the computerized tools for mapping of source to target database structures is associated with a computer or processor. A computer or processor comprises an electronic computing unit (e.g., a processor) operable to receive, transmit, process, store, or manage data and information associated with an operating environment of the database system. As used in the present disclosure, the term “computer” or “processor” is intended to encompass any suitable processing device. The term “processor” is to be understood as being a single processor that is configured to perform operations as defined by one or more aspects described in this disclosure, or the “processor” comprises two or more processors, that are configured to perform the same operations (e.g., in a manner that the operations are distributed among the two or more processors). The processor may comprise multiple organic field-effect transistors or thin film transistors or a combination thereof. This may allow processing the operations in parallel by the two or more processors. The two or more processors may be arranged within a supercomputer, the supercomputer may comprise multiple cores allowing for parallel processing of the operations. For instance, a computer or processor may be a desktop or a laptop computer, a cellular phone, a smartphone, a personal digital assistant, a tablet computer, an e-book reader or a mobile player of media. Furthermore, the operating environment of the database system can be implemented using any number of servers, as well as computers other than servers, including a server pool. Indeed, the computer or processor and the server may be any computer or processing device such as, for example, a blade server, general-purpose personal computer (PC), Macintosh, workstation, UNIX-based workstation, or any other suitable device. In other words, the present disclosure contemplates computers other than general purpose computers, as well as computers without conventional operating systems. Further, the computer, processor and server may be adapted to execute any operating system, including Linux, UNIX, Windows, Mac OS, iOS, Android or any other suitable operating system.

The term “computing device,” “server,” or “processor” encompasses all kinds of apparatus, devices, and machines for processing data, including by way of example a programmable processor, a computer, a system on a chip, or multiple ones, or combinations of the foregoing. The apparatus can include special purpose logic circuitry, e.g., an FPGA (field programmable gate array), a CUDA (Compute Unified Device Architecture) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and operating environment can realize various different computing model infrastructures. In enterprise systems, there are OLTP (OnLine Transaction processing) systems used to carry out business processes of a company where employees and other stakeholders, such as suppliers or customers, follow a business process which may result in business documents created in a database of the OLTP system. The database system can include in-memory databases in addition to the persistent databases described in connection with FIG. 1 and thereby exploit recent innovations in hardware to run a database in main memory. In an implementation of the present disclosure described herein, the servers may be types of a Java development platform, such as e.g., Enterprise JavaBeans® (EJB), J2EE Connector Architecture (JCA), Java Messaging Service (JMS), Java Naming and Directory Interface (JNDI), and Java Database Connectivity (JDBC), a ByDesign platform, SuccessFactors Platform, ERP Suite technology or in-memory database such as High Performance Analytic Appliance (HANA) platform. In an aspect, the servers may be based on two different of the above mentioned platforms.

Regardless of the particular implementation, “software” or “operations” may include computer-readable instructions, firmware, wired or programmed hardware, or any combination thereof on a tangible and non-transitory medium operable when executed to perform at least the processes and operations described herein. Indeed, each software component may be fully or partially written or described in any appropriate computer language including C, C++, Java, Visual Basic, assembler, Python and R, Perl, any suitable version of 4GL, as well as others.

The figures and accompanying description illustrate example processes and computer-implementable techniques. However, the database system operating environment (or its software or hardware components) contemplates using, implementing, or executing any suitable technique for performing these and other processes. It will be understood that these processes are for illustration purposes only and that the described or similar techniques may be performed at any appropriate time, including concurrently, individually, or in combination. In addition, many of the operations in these processes may take place simultaneously, concurrently, and/or in different orders or combinations than shown. Moreover, operating environment may use processes with additional operations, fewer operations, and/or different operations, so long as the methods remain appropriate.

Aspects of the subject-matter and the operations described in this specification can be implemented in digital electronic circuitry, semiconductor circuits, analog circuits, or in computer software, firmware, or hardware, including the structures disclosed in this specification and their structural equivalents, or in combinations of one or more of them. Embodiments of the subject-matter described in this specification can be implemented as one or more computer programs, i.e., one or more modules of computer program instructions, encoded on computer storage medium for execution by, or to control the operation of a data processing apparatus. Alternatively or in addition, the program instructions can be encoded on an artificially generated propagated signal, e.g., a machine-generated electrical, optical, or electromagnetic signal, which is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices). The operations described in this specification can be implemented as operations performed by a data processing apparatus on data stored on one or more computer-readable storage devices or received from other sources.

A computer program (also known as a program, software, software application, script, or code) or “user interface” can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The term “graphical user interface,” or GUI, may be used in the singular or the plural to describe one or more graphical user interfaces and each of the displays of a particular graphical user interface. Therefore, a GUI may represent any graphical user interface, including but not limited to, a web browser, a touch screen, or a command line interface (CLI) that processes information and efficiently presents the information results to the user. In general, a GUI may include a plurality of user interface (UI) “icons,” some or all associated with a web browser, such as interactive fields, pull-down lists, and buttons operable by the user of the computing device hosting the UI. These and other UI icons may be related to or represent the functions of the web browser. The term “browser user interface” refers to a graphical user interface embedded in a web browser environment on the remote computing device. The browser user interface may be configured to initiate a request for a uniform resource locator (URL) and may be configured to display a retrieved web page such as an HTML coded web page. The browser user interface may comprise displayed or hidden icons which, upon activation, initiate an associated electronic process inside or outside the remote computing device. For example, the browser user interface may be Internet Explorer, Chrome or Firefox. “Creating an icon” is to be understood as generating a new icon on the user interface. “Modifying an icon” is to be understood as changing a property of an existing icon on the user interface. “Deleting an icon” is to be understood as vanishing an existing icon on the user interface, e.g., for replacement by a newly created icon. “Updating the user interface” thereby is to be understood as creating, modifying, or deleting an icon on the user interface.

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer or computer or processor may be a processor for performing actions in accordance with instructions and one or more memory devices for storing instructions and data. Generally, a computer or computer or processor will also include, or be operatively coupled to receive data from or transfer data to, or both, one or more mass storage devices for storing data, e.g., magnetic, magneto optical disks, or optical disks. However, a computer or computing device need not have such devices. Moreover, a computer or computing device can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, implementations of the user interface described in this specification can be implemented on a computer having a non-flexible or flexible screen, e.g., a CRT (cathode ray tube), LCD (liquid crystal display) or OLED (organic light emitting diode) monitor, for displaying information to the user and a keyboard and a pointer, e.g., a finger, a stylus, a mouse or a trackball, by which the user can provide input to the computer. Other kinds of devices can be used to provide for interaction with a user as well; for example, feedback provided to the user can be any form of sensory feedback, e.g., touch feedback, visual feedback, auditory feedback, or tactile feedback; and input from the user can be received in any form, including acoustic, speech, touch or tactile input. In addition, a computer or computer or processor can interact with a user by sending documents to and receiving documents from a device that is used by the user; for example, by sending web pages to a web browser on a user's user device in response to requests received from the web browser.

Implementations of the subject-matter described in this specification can be implemented in a computing system that includes a back end component, e.g., as a server, or that includes a middleware component, e.g., an application server, or that includes a front end component, e.g., a user computer having a graphical user interface or a Web browser through which a user can interact with an implementation of the subject-matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include users and servers. A user and server are generally remote from each other and typically interact through a communication network. The relationship of user and server arises by virtue of computer programs running on the respective computers and having a user-server relationship to each other. In some implementations, a server transmits data (e.g., an HTML page) to a user device (e.g., for purposes of displaying data to and receiving user input from a user interacting with the user device). Data generated at the user device (e.g., a result of the user interaction) can be received from the user device at the server.

While this specification contains many specific implementation details, these should not be construed as limitations on the scope of any implementation or on the scope of what may be claimed, but rather as descriptions of features that may be specific to particular implementations of particular implementations. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems can generally be integrated together in a single software product or packaged into multiple software products.

Particular implementations of the subject matter have been described. Other implementations, alterations, and permutations of the described implementations are within the scope of the following claims as will be apparent to those skilled in the art. For example, the operations recited in the claims can be performed in a different order and still achieve desirable results.

Accordingly, the above description of example implementations does not define or constrain this disclosure. Other changes, substitutions, and alterations are also possible without departing from the spirit and scope of this disclosure.

What is claimed is:

1. A computer implemented method, comprising:
obtaining one or more source database structures including a plurality of source fields;
obtaining at least one target database structure including a plurality of target fields;
obtaining information regarding user interactions during a past mapping process of source fields of the one or more source database structures to target fields of the at least one target database structure;
automatically determining one or more proposed mappings between a set of source fields of the one or more source database structures and a set of target fields of the at least one target database structure,
wherein automatically determining the one or more proposed mappings includes taking into account the obtained information regarding user interactions during a past mapping process of source fields of the one or more source database structures to target fields of the at least one target database structure.

2. The computer-implemented method of claim 1, wherein the user interactions during a past mapping process include one or more of a definition of a mapping between a particular source field and a particular target field, a deletion of an existing mapping between a particular source field and a particular target field and a refusal of a proposed mapping between a particular source field and a particular target field.

3. The computer-implemented method of claim 1, wherein automatically determining the one or more proposed mappings includes:
obtaining weights for each mapping between the set of source fields and the set of target fields;
modifying at least one of the weights based on the obtained information regarding user interactions during a past mapping process; and
selecting a proposed mapping between each source field of the set of source fields and one of the target fields of the set of target fields based on the weights.

4. The computer-implemented method of claim 1, wherein selecting a proposed mapping between the each source field of the set of source fields and one of the target fields includes using a stable marriage algorithm.

5. The computer-implemented method of claim 3, wherein the weights obtained for each mapping between the set of source fields and the set of target fields are static weights.

6. The computer implemented method of claim 5, wherein the static weights are determined based on one or more of a data type of a source field and a respective target field, a similarity in the name or other identifier of a source field and a respective target field, a layout of the source database structure and a layout of the target database structure.

7. The computer implemented method of claim 3, wherein modifying at least one of the weights based on the obtained information regarding user interactions includes increasing a weight if the user has defined a mapping between a particular source field and a particular target field.

8. The computer implemented method of claim 3, wherein modifying at least one of the weights based on the obtained information regarding user interactions during a past mapping process includes:
determining one or more sets of source fields including one source field of two or more source database structures of the plurality of source database structures based on a similarity of proposed mappings between the source fields in each set of source fields and the plurality of target fields; and
modifying a weight of a mapping of at least one source field of each set of the one or more sets of source fields if a user past user interaction has defined, deleted or refused a mapping between another source database field of the respective set of source fields and a target field.

9. The computer implemented method of claim 3, wherein modifying at least one of the weights includes increasing a weight if the user has not refused or deleted a mapping between a respective source field and a respective target field in a past user interaction.

10. The computer implemented method of claim 1, wherein only information regarding a most recent user interaction for each source field and a respective target field is taken into account.

11. The computer implemented method of claim 1, wherein the mapping from the source fields to the target fields is injective.

12. The computer implemented method of claim 1, wherein the set of source fields includes all source fields of the two or more source database structures and the set of target fields includes all target fields of the at least one target database structure.

13. The computer implemented method of claim 1, further comprising:
presenting the one or more proposed mappings to the user for approval or refusal.

14. The computer implemented method of claim 1, further comprising:
presenting an indication to a user that one or more of the proposed mappings differ from the mappings that would be obtained when not taking into account the information regarding user interactions during a past mapping process.

15. The computer implemented method of claim 1, further comprising:
displaying at least a portion of a representation of the source database structures and the target database structure and an indication of proposed and actual mappings.

16. The computer implemented method of claim 15, further comprising:
updating the one or more proposed mappings after a user interaction; and
displaying an indication of the updated proposed and actual mappings.

17. The computer implemented method of any one of the preceding claims, the method further comprising:
comparing proposed mappings between source database fields of a particular source database structure of the one or more source database structures to target database fields of the target database structure with proposed mappings between source fields of one or more other source database structures of the one or more database structures to target fields of the target database structure; and
forming one or more sets of source database structures including source database fields which are mapped to the same target database field.

18. The computer implemented method of claim 17, the method further comprising replicating a past user interaction on a source database field of the one or more sets of source database fields on another source database field of the same set of source database field to automatically determine at least one proposed mapping.

19. A computer readable medium storing instructions thereon which when executed by a processor cause the processor to:
obtaining one or more source database structures including a plurality of source fields;
obtaining at least one target database structure including a plurality of target fields;
obtaining information regarding user interactions during a past mapping process of source fields of the one or more source database structures to target fields of the at least one target database structure;
automatically determining one or more proposed mappings between a set of source fields of the one or more source database structures and a set of target fields of the at least one target database structure,
wherein automatically determining the one or more proposed mappings includes taking into account the obtained information regarding user interactions during a past mapping process of source fields of the one or more source database structures to target fields of the at least one target database structure.

20. System comprising:
one or more processors; and
a computer-readable medium storing instructions executable by the one or more processors to perform operations comprising:
obtaining one or more source database structures including a plurality of source fields;
obtaining at least one target database structure including a plurality of target fields;
obtaining information regarding user interactions during a past mapping process of source fields of the one or more source database structures to target fields of the at least one target database structure;
automatically determining one or more proposed mappings between a set of source fields of the one or more source database structures and a set of target fields of the at least one target database structure,
wherein automatically determining the one or more proposed mappings includes taking into account the obtained information regarding user interactions during a past mapping process of source fields of the one or more source database structures to target fields of the at least one target database structure.
